(19) United States
(12) Patent Application Publication
(10) Pub. No.: US 2006/0118359 A1
(43) Pub. Date: Jun. 8, 2006

(54) Temporary railing for a building including tensioning apparatus and associated methods

(76) Inventor: Harrison G. Purvis, Eagle Springs, NC (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/265,590

(22) Filed: Nov. 2, 2005

Related U.S. Application Data
(60) Provisional application No. 60/624,206, filed on Nov. 2, 2004.
(60) Provisional application No. 60/630,019, filed on Nov. 22, 2004.
(60) Provisional application No. 60/641,385, filed on Jan. 4, 2005.
(60) Provisional application No. 60/669,503, filed on Apr. 8, 2005.

(51) Int. Cl. A62B 35/00; A62B 1/16

(52) U.S. Cl. 182/3

(57) ABSTRACT

A temporary railing for a boundary of the building floor may include a plurality of temporary cable supports spaced along the boundary of the building floor, a plurality of vertically spaced apart cables carried by the temporary cable supports, and a portable cable tensioning apparatus coupled to the cables to maintain a desired tension therein and to take-up slack therein to maintain the desired tension. For example, the portable cable tensioning apparatus may include a portable frame, and a weight load movably carried by the portable frame and coupled to the cables.

### RELATED APPLICATIONS

The present application is based upon U.S. Provisional Application Nos. 60/624,206 filed Nov. 2, 2004; 60/630,019 filed Nov. 22, 2004; 60/641,385 filed Jan. 4, 2005 and 60/669,503 filed Apr. 8, 2005; the entire subject matter of each of which is incorporated herein by reference.

### FIELD OF THE INVENTION

The present invention relates to the field of construction, and, more particularly, to the field of temporary railings for buildings and associated methods.

### BACKGROUND OF THE INVENTION

A temporary railing may be used to protect construction workers at an elevated construction site. Such a temporary railing may generally employ a series of stanchions spaced around the boundary of a building floor and a set of parallel cables carried by the stanchions. The parallel cables are manually tensioned by turnbuckles and/or winches to thereby form a substantially rigid grid on the boundary or perimeter of the construction site. For example, such a typical railing is disclosed in U.S. Pat. No. 6,053,281 to Murray, wherein winches are used to set the initial tension of the cables. U.S. Pat. Nos. 3,881,699 and 6,270,057 also disclose conventional temporary railings for a building floor.

Another type of building fall protection system includes a safety cable or safety line to which the lanyard of a worker's safety harness may be slidably connected while erecting a steel framework, for example, as disclosed in U.S. Pat. No. 6,036,146. U.S. Pat. No. 6,412,598 to Mackinnon discloses a similar safety line as does U.S. Pat. No. 6,270,057 to Highley et al. Such a safety line typically is required to provide a shock absorbing feature should a worker fall, such as disclosed in U.S. Pat. No. 5,332,071. In contrast, it is generally desired that a temporary railing for a building floor apply a relatively large tension to the cables, and that the cables are not readily moved by contact by a worker, for example.

Unfortunately, the current temporary railings need periodic manual adjustments to maintain the cable tension to counteract the elongation of the cables, and/or the slight movement of various stanchions that would otherwise cause slack and thereby release the cable tension. Such a manual maintenance requirement can require many man hours, especially where temporary railings are used on multiple floors of a building.

Another drawback of a conventional cable railing is that it typically requires that the entire railing be released and lowered to permit a user to move heavy equipment past the railing. Alternatively, the heavy equipment needs to be lifted over the railing.

The boundary of a typical building floor may also include various corners. A simple eye for receiving the cable can be attached to a vertical building member at a corner, but is likely to increase resistance to tensioning. Of course, the corner may be inside or outside corners depending on the railing.

### SUMMARY OF THE INVENTION

In view of the foregoing background, it is therefore an object of the present invention to provide a temporary railing for a boundary of a building floor that can account for the elongation of the cables or other causes typically requiring periodic manual inspection and tightening.

This and other objects, features and advantages in accordance with the invention are provided by a temporary railing for a boundary of the building floor comprising a plurality of temporary cable supports spaced along the boundary of the building floor, a plurality of vertically spaced apart cables carried by the temporary cable supports, and a portable cable tensioning apparatus coupled to the cables to maintain a desired tension therein and to take up slack in the cables to maintain the desired tension. Accordingly, the periodic manual tightening of the cables can be avoided with significant manpower savings.

For example, the portable cable tensioning apparatus may include a portable frame, and a weight load movably carried by the portable frame and coupled to the cables. The weight load may comprise a stack of removable plates. In addition, the portable cable tensioning apparatus may further comprise a pulley arrangement coupled between the weight load and the cables for multiplying tension applied to the cables by the weight load. The portable cable tensioning apparatus may further include a winch carried by the portable frame, a yoke coupled to the cables, and a take-up cable having a first end coupled to the winch, a second end coupled to the weight load, and a medial portion extending through the yoke and the pulley arrangement. In addition, the portable cable tensioning apparatus may further comprise a yoke guide carried by the frame and guiding the yoke.

In accordance with another class of embodiments, the portable cable tensioning apparatus may comprise a portable frame, a cylinder carried by the portable frame, a controllable fluid pressure source, and a piston coupled to the cables and movable within the cylinder responsive to the controllable fluid pressure source. Moreover, the controllable fluid pressure source may comprise at least one of a controllable hydraulic fluid pressure source and a controllable pneumatic fluid pressure source.

The plurality of temporary cable supports may comprise at least one stanchion temporarily secured to the building floor. The at least one stanchion may have an adjustable height. The building may comprise at least one vertical building member, and the temporary cable supports may comprise at least one pulley temporarily secured to the at least one vertical building member. For example, the pulley may comprise a dual-use corner pulley suitable for inside or outside corner mounting. The temporary railing may further include an access opening assembly for permitting temporary establishment of an access opening through the cables.

A method aspect is for establishing a temporary railing for a boundary of a building floor. The method may include positioning a plurality of temporary cable supports spaced along the boundary of the building floor, positioning a plurality of vertically spaced apart cables carried by the temporary cable supports, and coupling a portable cable tensioning apparatus to the cables to maintain a desired tension therein and to take-up slack therein to maintain the desired tension.

### BRIEF DESCRIPTION OF THE DRAWINGS

FIG. 1 is a schematic diagram of a portion of a temporary railing according to the invention.

FIG. 2 is a schematic diagram of the portable cable tensioning apparatus in FIG. 1.

FIG. 3 is another schematic diagram of a portion the portable cable tensioning apparatus in FIG. 1.

FIG. 4 is another schematic diagram of a portion the portable cable tensioning apparatus in FIG. 1.

FIG. 5 is a schematic diagram of an alternative embodiment of the portable cable tensioning apparatus in FIG. 1.

FIG. 6 is a schematic diagram of the alternative embodiment of the portable cable tensioning apparatus in FIG. 5.

FIG. 7 is a schematic diagram of an alternative embodiment of a portable cable tensioning apparatus to be used in the temporary railing in accordance with the present invention.

FIG. 8 is a schematic diagram of another alternative embodiment of a portable cable tensioning apparatus to be used in the temporary railing in accordance with the present invention.

FIG. 9 is a side elevation view of a primary cable clamp for defining an access opening in the temporary railing in accordance with the invention.

FIG. 10 is a side elevation view of a cable jack for defining an access opening in the temporary railing in accordance with the invention.

FIG. 11 is a front elevation view of the connecting link of the cable jack of FIG. 10.

FIG. 12 is a side elevation view of the extension arm of the cable jack of FIG. 10.

FIG. 13 is a top plan view of the hinge pin of the cable jack of FIG. 10.

FIG. 14 is a top plan view of the cable jack of FIG. 10.

FIGS. 15-18 are side perspective views of the primary and second cable clamps of the temporary railing illustrating securing for defining an access opening in accordance with the invention.

FIG. 19 is a side perspective view of the primar and secondary cable clamps shown in the clamped position in accordance with the invention.

FIG. 20 is a top perspective view of a cable jack for defining an access opening in the temporary railing in accordance with the invention.

FIG. 21 is a top perspective view of the cable jack in FIG. 20 show in the released position.

FIG. 22 is a schematic diagram of a section of the temporary railing in accordance with the invention illustrating the components for establishing the access opening.

FIG. 23 is a schematic plan view of the temporary railing in accordance with the invention.

FIG. 24 is an enlarged perspective view of an embodiment of a fastening arrangement for the bottom plate of the cable tensioning apparatus shown in FIG. 3.

FIG. 25 is an end elevation view of an alternative embodiment of the cable tensioning apparatus in accordance with the invention and illustrated with the mesh doors removed for clarity.

FIG. 26 is a side elevation view of the alternative embodiment of the cable tensioning apparatus shown in FIG. 25.

FIG. 27 is an end elevation view of an alternative embodiment of the cable tensioning apparatus in accordance with the invention and illustrated with the mesh doors in place.

FIG. 28 is a side elevation view of the alternative embodiment of the cable tensioning apparatus shown in FIG. 27.

FIG. 29 is an end elevation view of an alternative embodiment of the cable tensioning apparatus in accordance with the invention and illustrated with the mesh doors in place and showing interior portions.

FIG. 30 is a side elevation view of the alternative embodiment of the cable tensioning apparatus shown in FIG. 29.

FIG. 31 is an end elevation view of yet another alternative embodiment of the cable tensioning apparatus as shown in FIG. 8.

FIG. 32 is a side elevation view of the cable tensioning apparatus as shown in FIG. 31.

FIG. 33 is a side elevation view of the cable tensioning apparatus as shown in FIGS. 27 and 28 with a side door open.

FIG. 34 is an interior perspective view of top pulleys in the cable tensioning apparatus as shown in FIG. 33.

FIG. 35 is another interior perspective view of further pulleys in the cable tensioning apparatus as shown in FIG. 33.

FIG. 36 is another interior perspective view of lower pulleys in the cable tensioning apparatus as shown in FIG. 33.

FIG. 37 is a perspective view of cable yoke and associated pulleys in the cable tensioning apparatus shown in FIG. 33.

FIG. 38 is a top plan view of an embodiment of a corner pulley for use in the temporary railing in accordance with the invention.

FIG. 39 is a front elevation view of the pulley shown in FIG. 38.

FIG. 40 is a side elevational view of the pulley shown in FIG. 38.

FIG. 41 is a top perspective view of another embodiment of a corner pulley for use in the temporary railing in accordance with the invention.

FIG. 42 is a side elevation view of the corner pulley as shown in FIG. 41.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notations are used in alternative embodiments to indicate similar elements.

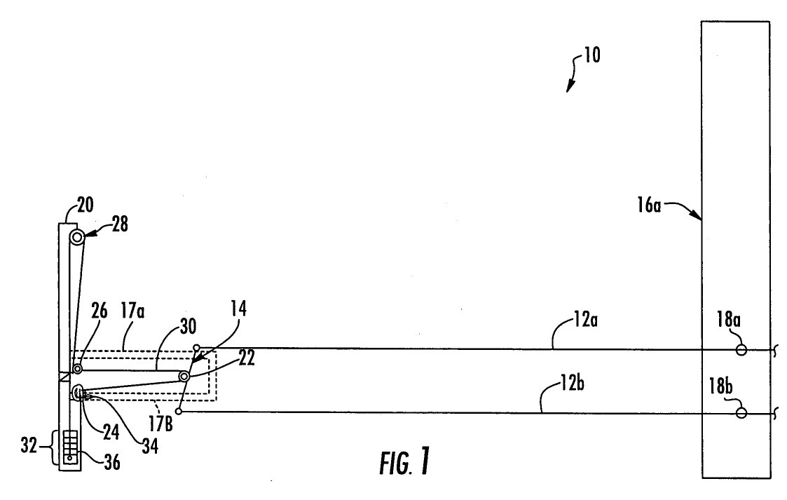

The basic components and interconnections of a temporary railing 10 in accordance with the invention are now described with reference to FIG. 1. The temporary railing 10 illustratively includes a pair of cables 12a, 12b strung between a stanchion 16a and a yoke 14. The stanchion 16a may be a column and/or other vertical building member as will be appreciated by those of skill in the art.

One end of each of the cables 12a, 12b terminates at the yoke 14 and the yoke is connected to a yoke pulley 22. The yoke 14 accommodates different lengths for the cables 12a, 12b by pivoting around the axis of the yoke pulley 22.

The cables 12a, 12b pass through guide eyehooks 18a, 18b that are fastened to the stanchion 16a. The guide eyehooks 18a, 18b serve to help maintain the position of the cables 12a, 12b in relation to the stanchion 16a. Other positioning devices similar to guide eyehooks 18a, 18b are also envisioned as will be appreciated by those skilled in the art. Horizontally extendable sliding rails 17a, 17b extend outwardly from the cable tensioning apparatus or tower 20 as used hereafter and may assist in preventing the cables 12a, 12b from twisting by maintaining the yoke 14 in the proper plane.

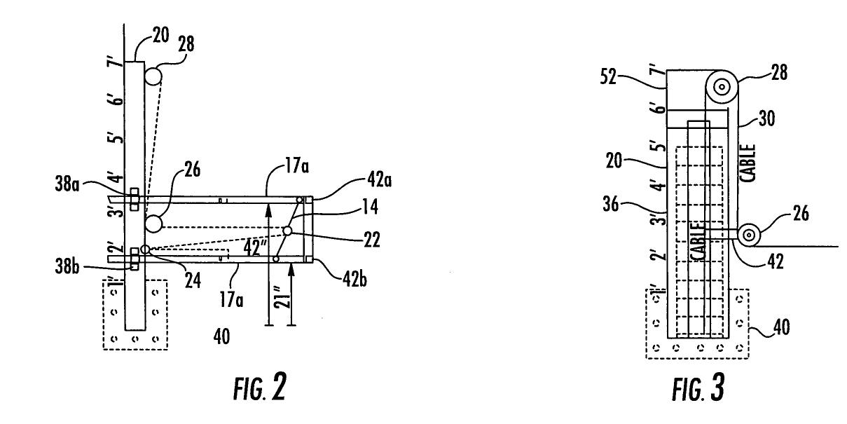

Referring additionally to FIG. 2, one end of each adjustable sliding rail 17a, 17b is fitted to slide through respective brackets 38a, 38b. A thumbscrew may be arranged in the surface of each of the brackets 38a, 38b to enable the adjustable sliding rails 17a, 17b to be fixed in position when each thumbscrew is turned until it bottoms out against each respective adjustable sliding rail 17a, 17b. The adjustable sliding rails 17a, 17b are also illustratively shown to include twist eyehooks 42a, 42b that may help to keep the fall protection cables 12a, 12b from twisting.

The tower 20 may support a medial pulley 26 and an upper pulley 28 that are spaced apart on the tower. The tower 20 may also carry a tower set point winch 24 that is used to tension a tower cable 30.

The cable 30 is strung through the tower set point winch 24, yoke pulley 22, medial pulley 26, and upper pulley 28. The end of the tower cable 30 from the upper pulley 28 is connected to the removable weights 32. The weights may move in a path that may be guided by the tower 20.

The weight stack 32 provides a tensioning force on tower cable 30. The force is transmitted along the tower cable 30 where it exerts a force on the yoke 14 thereby keeping the cables 12a, 12b under a selected tension even during elongation of the cables or based upon slight movement of the cable supports as will be appreciated by those skilled in the art. Adding or subtracting any number of weight plates 36 to the tower weight stack 32 may be used to adjust the tension force generated.

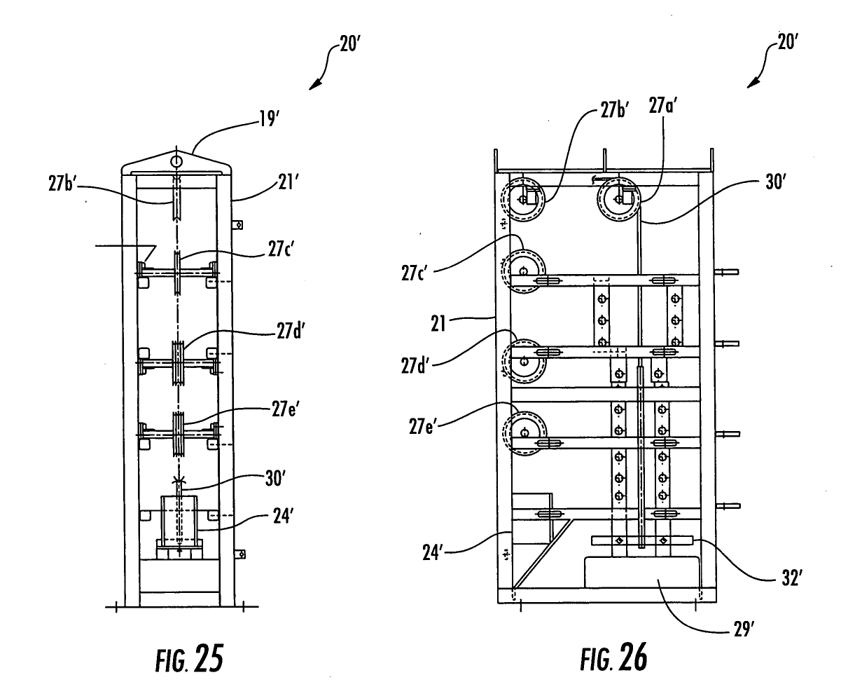

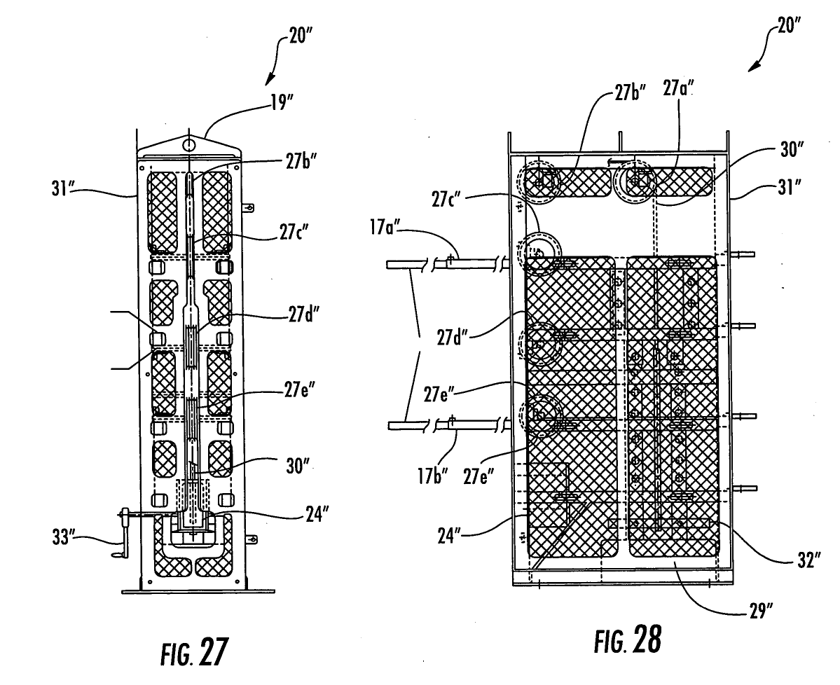

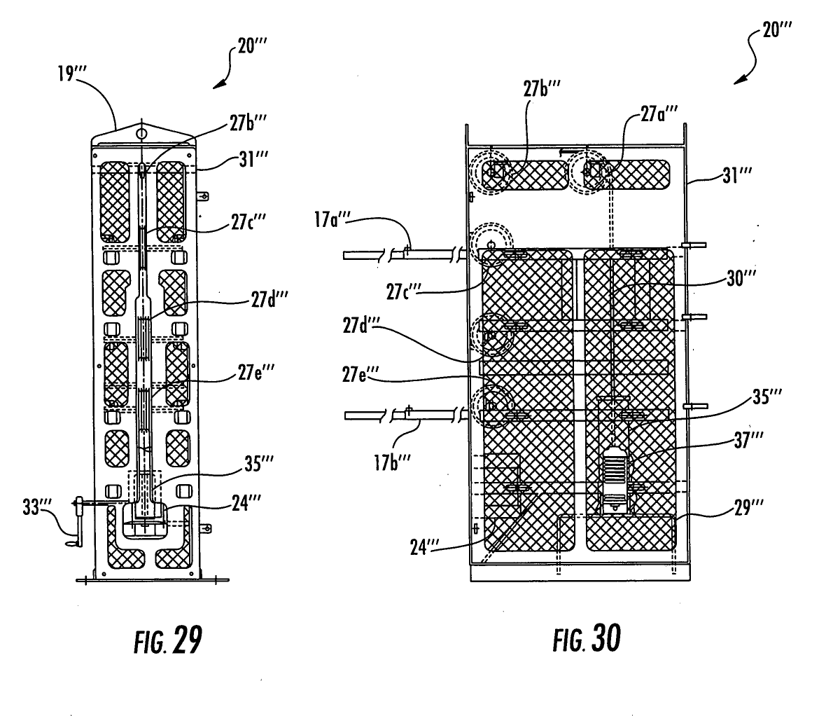

Turning now additionally to FIGS. 25-28, alternative embodiments of the tower 20′, 20″ are now described. The towers 20′, 20″ are fabricated from square tubing although other materials such as round tubing and angle iron may also be used. Transport brackets 19′, 19″ are illustratively shown mounted on top of the towers 20′, 20″. The transport brackets 19′, 19″ each have a hole through which a cable, clevis hook, shackle clevis or the like may be attached to readily facilitate the transport of the towers 20′, 20″ as will be appreciated by those of skill in the art. Each of the internal cables 30′, 30″ is strung through a plurality of pulleys 27a′-27e′ and 27a″-27e″ connected to the towers 20′, 20″.

Each of the internal cables 30′, 30″ is connected to the respective weight stack 32′, 32″. The tension of each of the internal cables 30′, 30″ is controllable by adjusting the weight stack 32′, 32″. Rotating the winch handle 33″ of tower set point winch 24′, 24″ permits setting the length of the internal cable 30′, 30″ so that the weight stack 32′, 32″ does not move to the bottomed out position during normal operation as will be appreciated by those skilled in the art.

Each of the towers 20′, 20″ illustratively includes side panels 30′, 31″ made of sheet metal and wire mesh to thereby enclose the internal components of the tower as will be appreciated by those of skill in the art. The towers 20′, 20″ illustratively include storage holds 29′, 29″ at the bottom area.

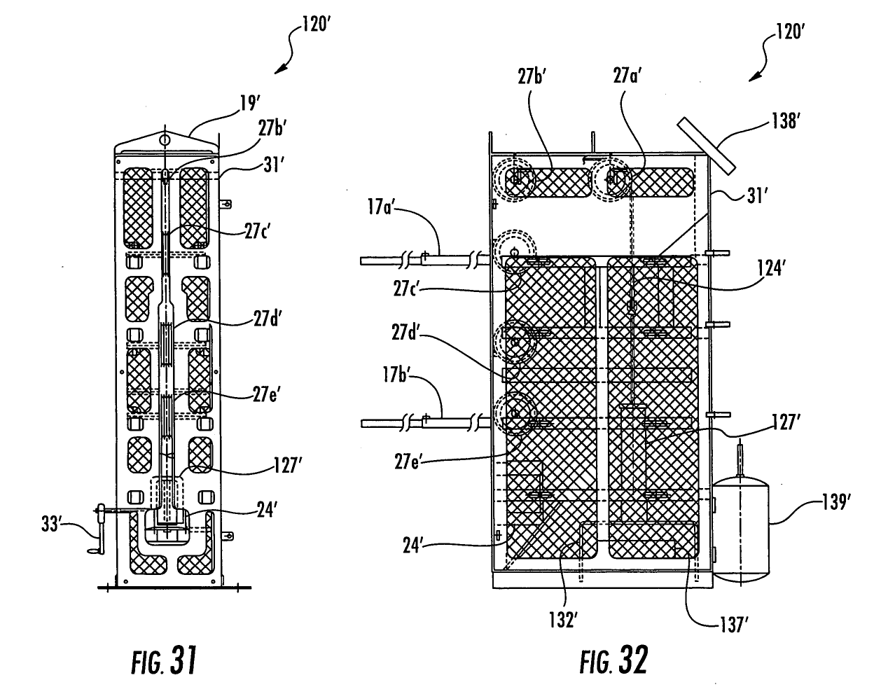

Referring additionally to FIGS. 29 and 30, in an alternative embodiment, the force transmitted on the tower cable 30 may be applied by a tension spring 37′″ or the like as will be appreciated by those skilled in the art. The tension spring 37′″ is carried by housing 35′″.

The tower 20 is shown as having a bottom plate 40 at one end of the tower (See FIGS. 2 and 3). The bottom plate 40 may be used to fasten the tower 20 in a selected position by bolting the bottom plate directly to the floor of the installation site, for example.

Alternately, as illustrated in FIG. 24, the bottom plate 40 may be elevated off the floor of the installation site by using a combination of all-threaded rods 25a-25d and a plurality of all-threaded rod fasteners 27a-27d such as nuts as will be appreciated by those of skill in the art. Additionally, each all-threaded rod 25a-25d may be connected to a respective optional foot 29a-29d. The elevated position of the bottom plate 40 permits the tower 20 to be installed on an unfinished surface, which will receive concrete poured at later date, for example. The elevated configuration permits the concrete to be poured without the tower 20 being moved. For instance, after the concrete is poured, the tower 20 can be removed and the all-threaded rods 25a-25d may be cutoff flush with the floor as will be appreciated by those of skill in the art.

In another embodiment of the invention, each of the all-threaded rods 25a-25d may be sleeved in a properly sized piece of pipe (not shown) such as PVC pipe to protect the all-threaded rods 25a-25d from the concrete poured to produce the finished floor surface. After the concrete pour, the all-threaded rods 25a-25d may be unscrewed from the new concrete floor, the PVC pipe may be cut flush with the new floor surface, and the remaining holes patched.

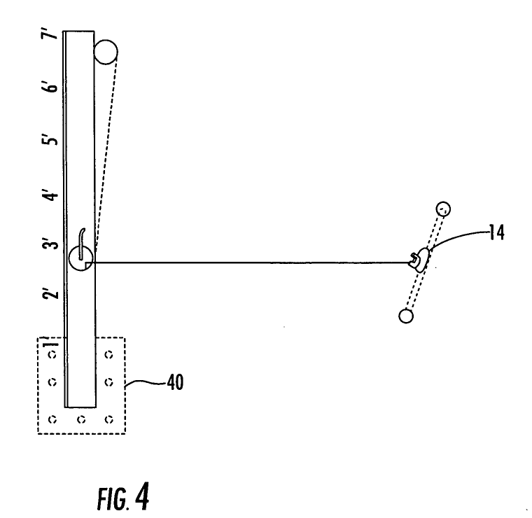

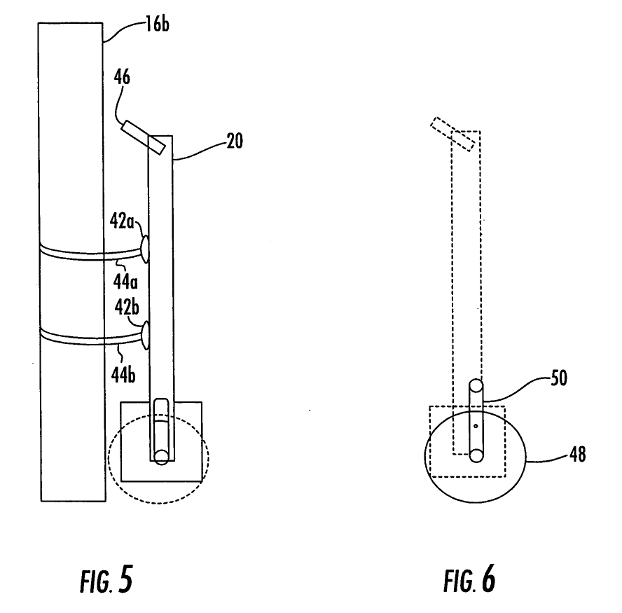

Referring now additionally to FIGS. 3, 4, 5, and 6A, the medial pulley 26 is fastened to the tower 20 by a bracket 42, and the tower 20 may be carried by a tower housing 52. The fall protection cables 12a, 12b may be pulled to the tower 20 by a winching device as is shown in FIG. 4. A pair of chain loops 42a, 42b are shown in FIG. 5 and may be fastened to the tower 20. The chain loops 42a, 42b enable the tower 20 to be secured to a stanchion 16b or vertical building member 16a by respective chains 44a, 44b.

The tower 20 may also include a set of wheels 48 that facilitate the movement of tower 20 to different locations, and a handle 46 that aids in the positioning of tower 20. The tower 20 may also include an adjustable level 50 that is used to position the height of the set of wheels 48 in relation to tower 20. For example, the adjustable level 50 may be used to raise the set of wheels 48 in relation to the tower 20 thereby allowing the base of tower to contact the ground. As such, the tower 20 may be easier to secure in a selected position.

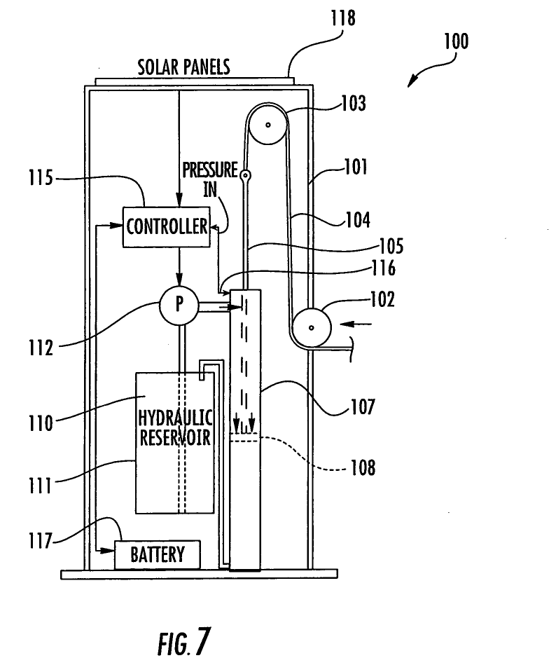

Turning now additionally to FIG. 7 another embodiment of a tower 100 is now described. The tower 100 includes a housing or frame 101 that illustratively carries two pulleys 102, 103 for directing a tensioning cable 104 from the yoke as described above (not shown here for clarity) to the piston rod 105 of the hydraulic cylinder 107. The piston rod 105, in turn, is connected to a piston 108 within the cylinder as will be appreciated by those skilled in the art.

A hydraulic fluid 110 is supplied from the hydraulic reservoir 111 to the high pressure side of the cylinder 107 by the hydraulic pump 112 under control of the controller 115. The controller 115 is connected to a pressure sensor 116 that is, in turn, connected to the cylinder 107. A control panel, not shown, may be used by an operator to set a desired tension that will be used by the controller 115 to control the hydraulic pressure to thereby maintain the selected tension on the guard cables. The controller 115 and pump 112 are illustratively electrically powered via a storage battery 117 that may be recharged during daylight hours by the solar panels 118 as will be appreciated by those skilled in the art. Other powering schemes are also contemplated by the present invention.

Another tower 120 embodiment is now described with reference to FIG. 8. In this tower 120, a pneumatic or air pump 132 is used to maintain the desired air pressure in the cylinder 127 to thereby maintain the desired tension in the guard cables. The tower 120 includes a housing or frame 121 that illustratively carries two pulleys 122, 123 for directing a tensioning cable 124 from the yoke as described above (not shown here for clarity) to the piston rod 125 of the hydraulic cylinder 127. The piston rod 125, in turn, is connected to a piston 128 within the cylinder as will be appreciated by those skilled in the art. Air is supplied to the high pressure side of the cylinder 127 by the air pump 132 under control of the controller 135. The controller 135 is connected to a pressure sensor 136 that, in turn, is connected to the cylinder 127.

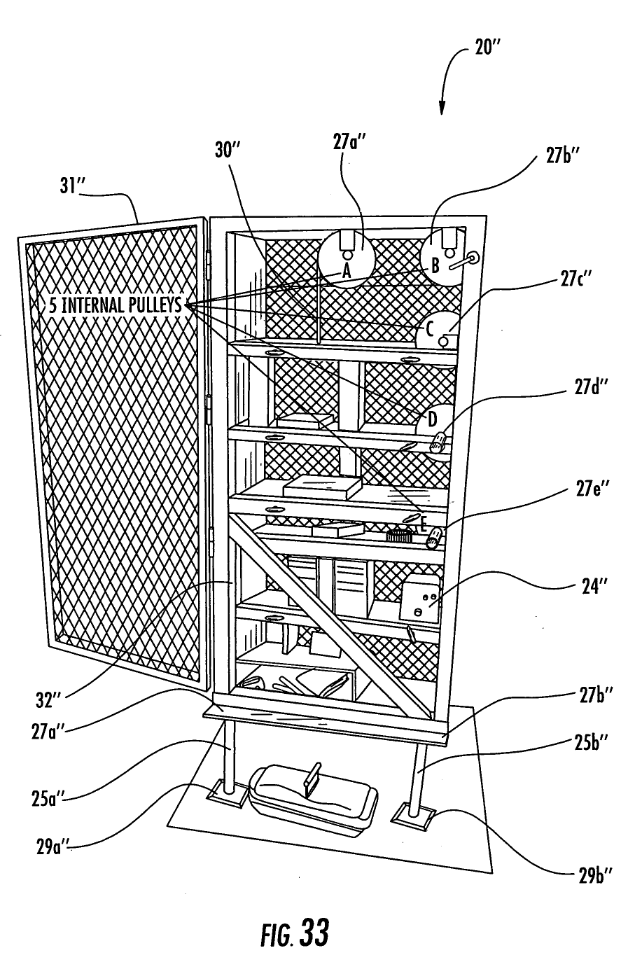

A control panel, not shown, may be used by an operator to set a desired tension that will be used by the controller 135 to control the air pressure to thereby maintain the selected tension on the guard cables. The controller 135 and pump 132 are illustratively electrically powered via a storage battery 137 that may be recharged during daylight hours by the solar panels 138 as will be appreciated by those skilled in the art. Other powering schemes are also contemplated by the present invention. Referring now additionally to FIGS. 31 and 32, in an alternate embodiment of tower 120′, an air supply tank 139′ is connected to the hydraulic cylinder 127′ and air pump 132′ as will be appreciated by those of skill in the art.

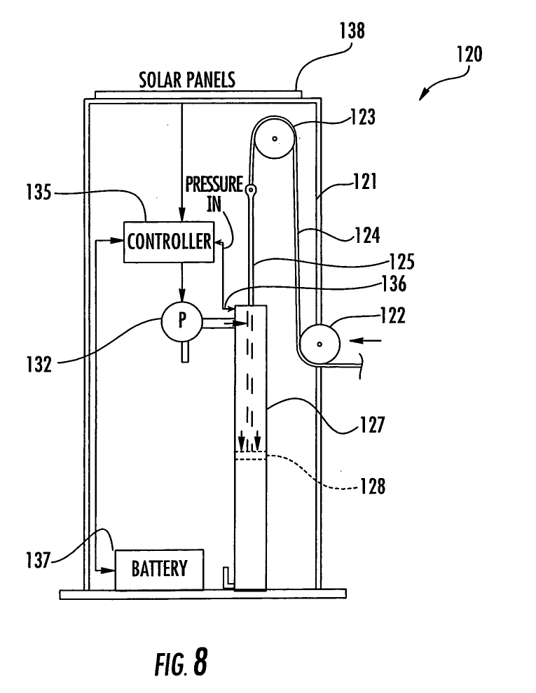

Referring now to FIG. 9, a cable clamp 60 used in conjunction with the temporary railing 10 is now described. The cable clamp 60 includes cable gripping jaws 62a, 62b that are operable to securely hold one of the fall protection cables 12a, 12b, for example, when handles 64a, 64b are in a closed position. Moving the handle 64a away from the handle 64b, the open position, releases the cable gripping jaws 62a, 62b from a respective fall protection cable 12a, 12b.

The gap between the cable gripping jaws 62a, 62b may be adjusted by an adjustment screw 66 located at one end of the handle 64a as will be appreciated by those of skill in the art. The cable clamp 60 may be fabricated by modifying a set of curved jaw locking pliers to include handles 64a, 64b although other embodiments will be apparent to one skilled in the art. The cable clamp 60 further includes a tether 68 connected to a threaded U-bolt 70.

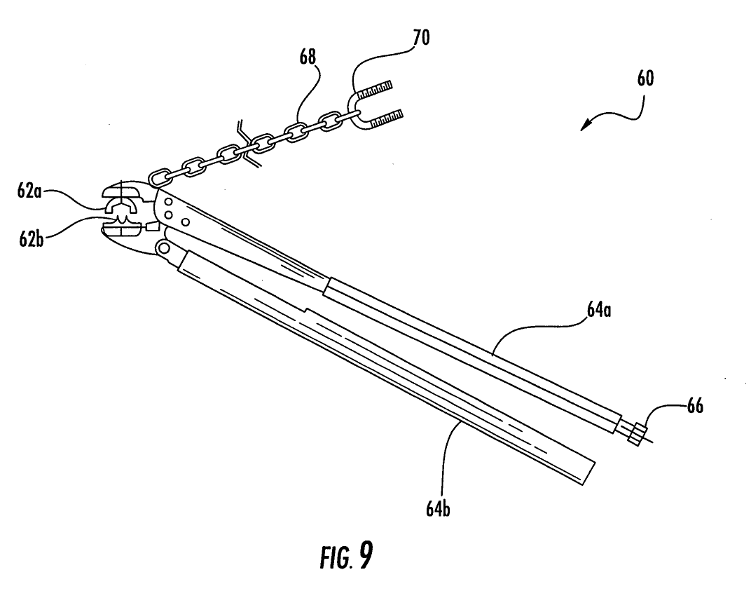

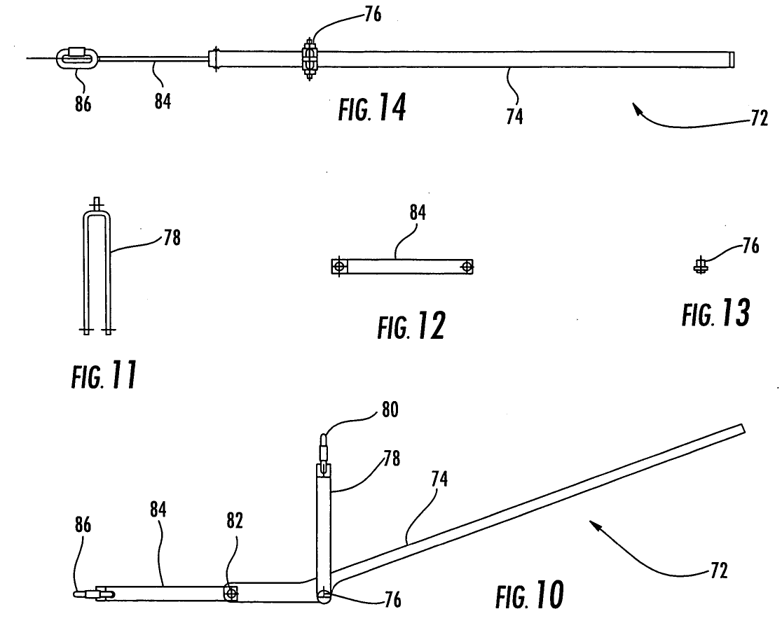

Referring now to FIGS. 10-14, a cable jack 72 used in conjunction with the temporary railing 10 and the cable clamp 60 is now described. The cable jack 72 includes a handle 74 rotatably connected at a medial position by a pivot member 76 to a first member 78, which is connected to a carabiner 80. One end of the handle 74 is connected by a pin 82 to a second member 84, which is connected to a handle carabiner 86.

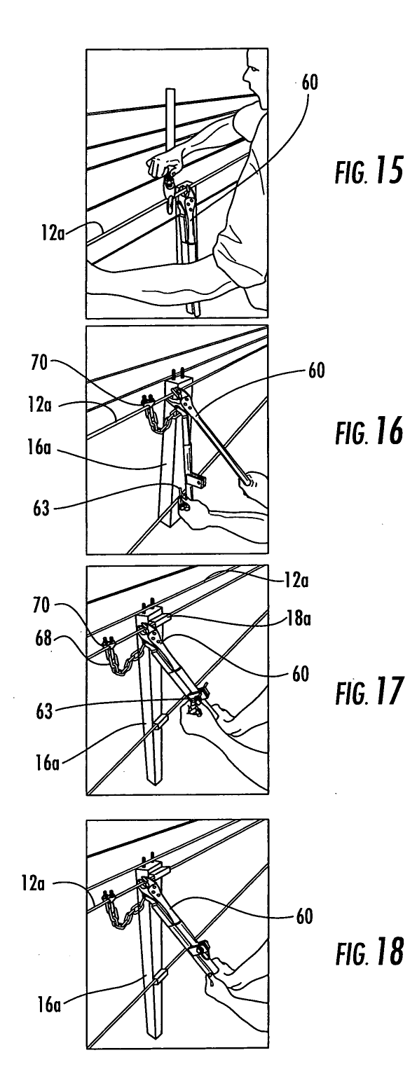

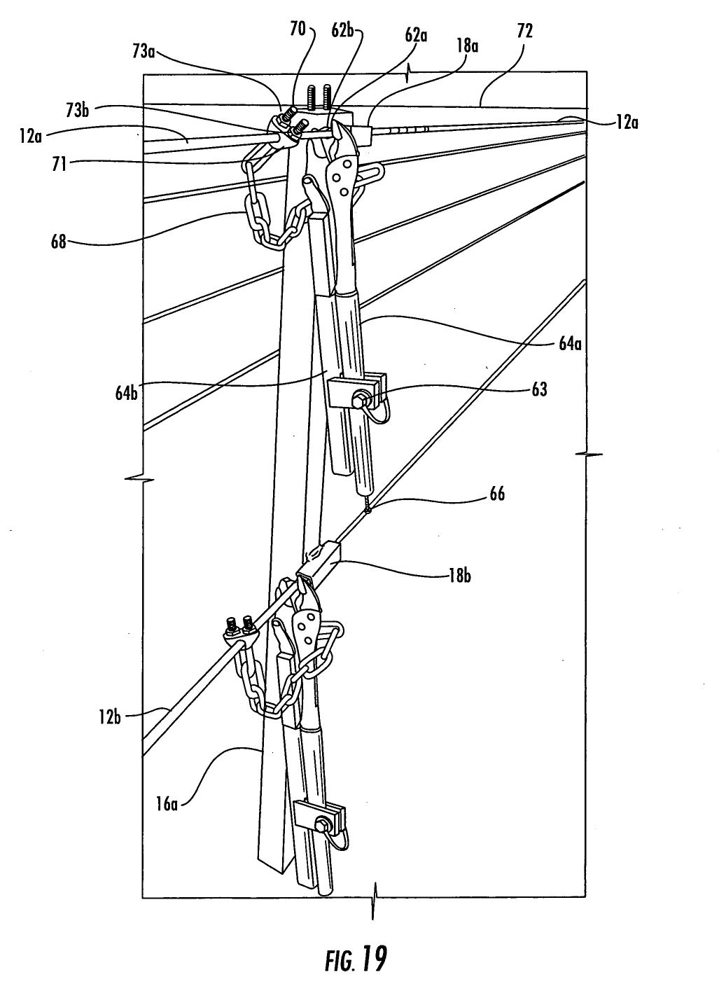

The cable clamp 60 is positioned onto one of the fall protection cables 12a, 12b as is illustrated in FIGS. 15-19. The threaded U-bolt 70 is placed onto the fall protection cable 12a near the guide eyehook 18a of the stanchion 16a. The threaded U-bolt 70 may then be secured to the fall protection cable 12a by a backing plate 71 fastened to the threaded U-bolt 70 by nuts 73a, 73b as will be appreciated by those of skill in the art. The secured U-bolt 70 may act as a back-up clamp 69 to the primary cable clamp 60.

The cable gripping jaws 62a, 62b may be positioned on the fall protection cable 12a between the back-up clamp 69 and the adjacent guide eyehook 18a. The handles 64a, 64b are then moved to the closed position (FIG. 17) thereby closing the cable gripping jaws 62a, 62b securely around the fall protection cable 12a. The handles 64a, 64b may then be locked in the closed position by a locking pin 63 (FIG. 17). Thus, the cable gripping jaws 62a, 62b create a stop to keep the fall protection cable 12a from traveling through the guide eyehook 18a when the fall protection cable 12a on the side of the guide eyehook 18a without the attached cable clamp 60 remains under tension.

As will be appreciated by those of skill in the art, the temporary railing 10 may employ a plurality of stanchions 16a-16j that include any combination of permanent and temporary stanchions. A second cable clamp 60 and back-up clamp 69 may be attached to the fall protection cable 12a in a manner similar to the first cable clamp 60 and the back-up clamp 69, but adjacent a stanchion 16c instead of the stanchion 16a.

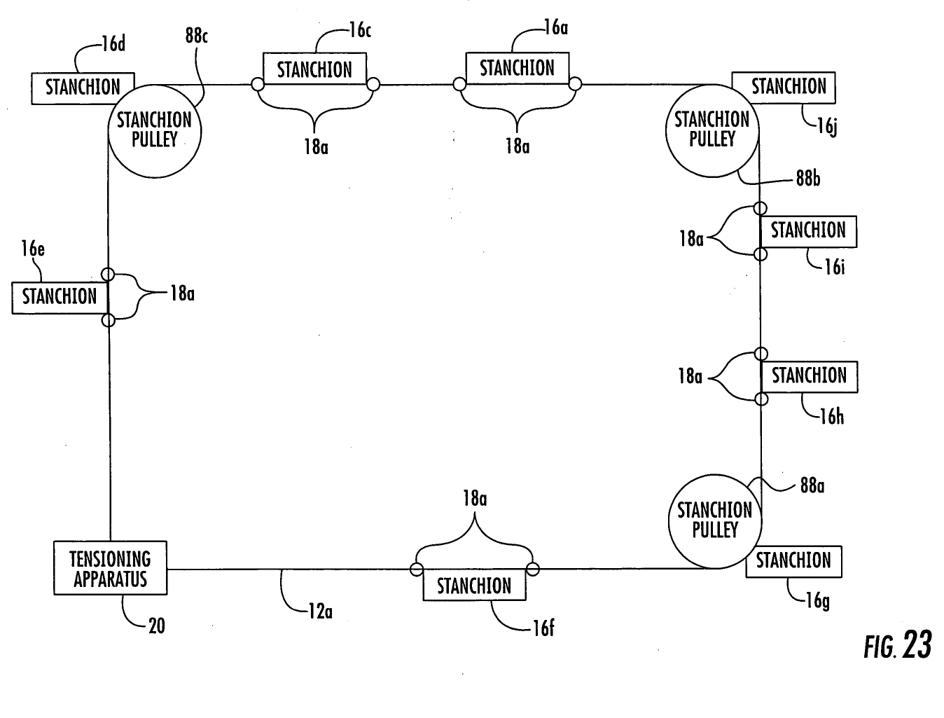

A cable jack 72 may be connected to the fall protection cable 12a between the first and second back-up clamps 69. In other words, referring now to FIG. 22, the layout along the fall protection cable 12a is the stanchion 16a, the first primary cable clamp 60, the first back-up clamp 69, the cable jack 72, the second back-up clamp 69, the second primary cable clamp 60, and then the stanchion 16c.

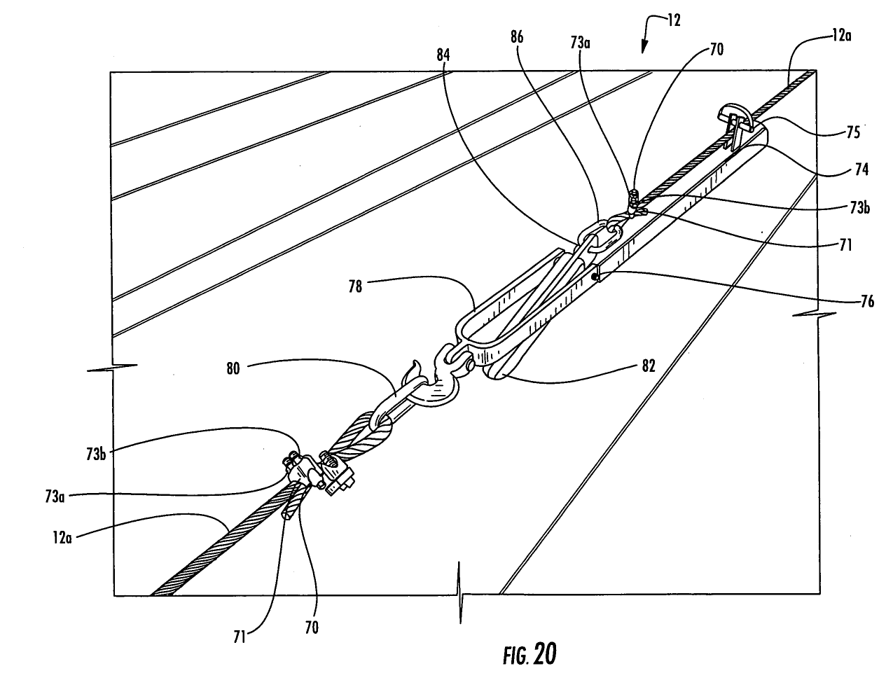

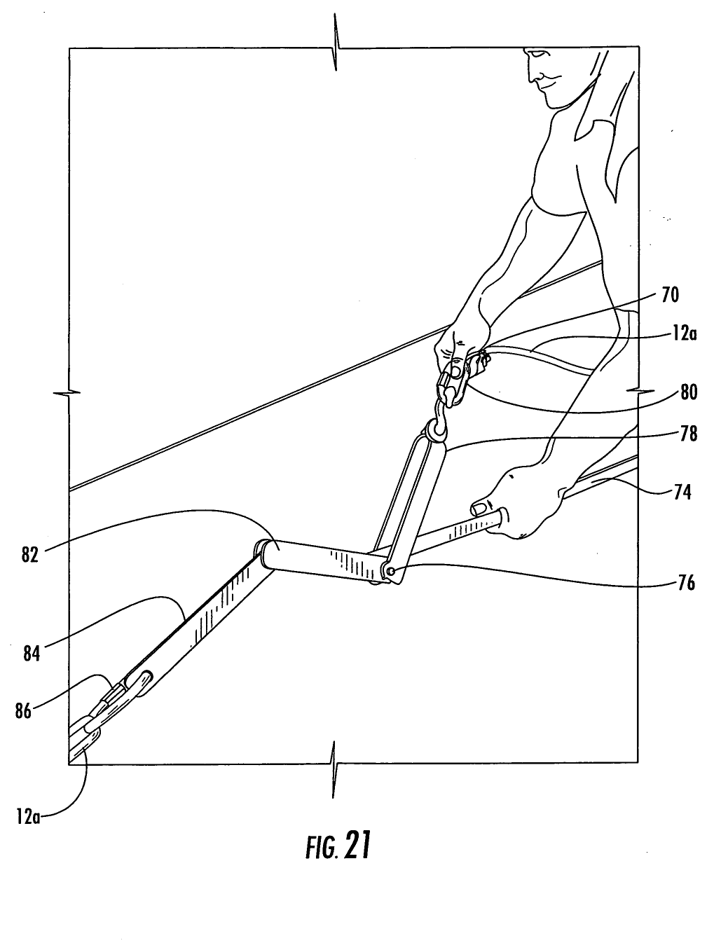

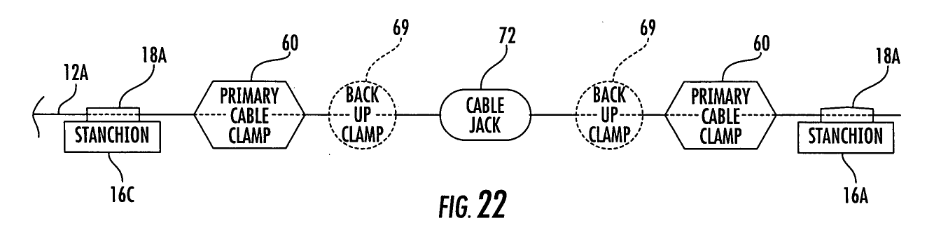

Referring now additionally to FIGS. 20 and 21, the cable jack 72 is connected to one end of the fall protection cable 12a by the connecting link carabiner 80, and on the other end by the handle carabiner 86. Of course, other methods of attachment are possible as will be appreciated by those of skill in the art.

FIG. 20 illustrates the cable jack 72 in a closed position whereby the cable jack 72 transmits the tension from one end of the fall protection cable 12a to the other end of the fall protection cable 12a. The cable jack 72 may be locked into the closed position by a cable jack lock 75, which secures the handle 74 in a position adjacent to the fall protection cable 12a.

With the first and second cable clamps 60 secured into place on the fall protection cable 12a as described above, the cable jack 72 may be opened as illustrated in FIG. 21. As a result, it is possible for a user to unconnect the two ends of the fall protection cable 12a from the cable jack 72 and move them out of the way thereby permitting the user to move a load or equipment through an area between the stanchions 16a and 16c illustrated in FIG. 22. In addition, the rest of the fall protection cable 12a remains under tension because the first and second cable clamps 60 securely hold the remaining sections of the fall protection cable 12a under tension. In contrast, a conventional temporary railing system does not typically permit a section of the cable to be released from tension to permit user access through the area guarded by the temporary railing while the other sections of the same temporary railing remain under tension.

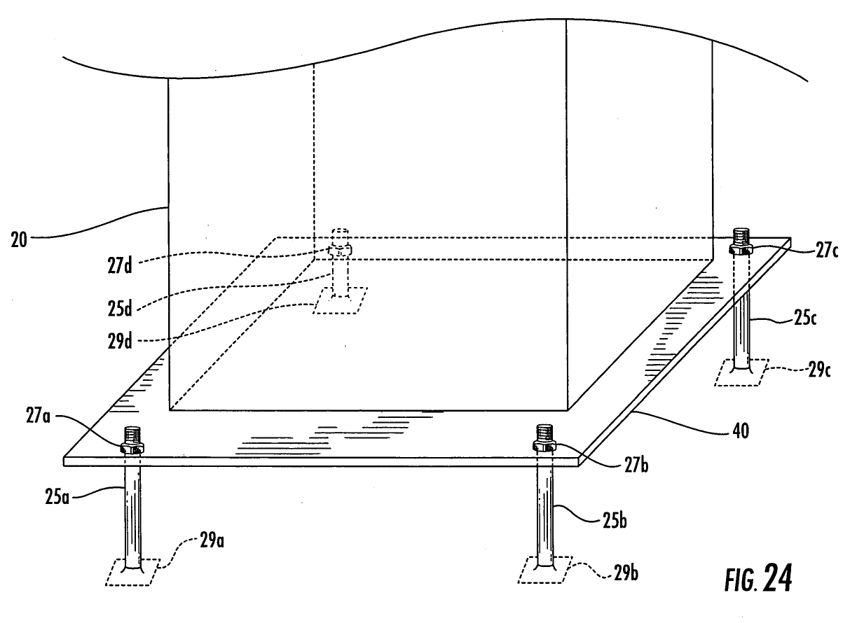

Referring now additionally to FIG. 23, the temporary railing 10 may further include dual-use corner pulleys 88a-88c. The dual-use corner pulleys 88a-88c may be attached to any one of the stanchions 16a-16i, for example. The fall protection cable 12a may be routed around the dual-use corner pulleys 88a-88c and through a plurality of guide eyehooks 18a to facilitate the transmission of tension generated at the tower 20 by the tower weights 32, not shown, for example. The dual-use corner pulleys 88a-88c are illustrated as connected on the inside corners of the temporary railing 10, however, the dual-use corner pulleys 88a-88c may also be connected to the stanchions on the outside corners.

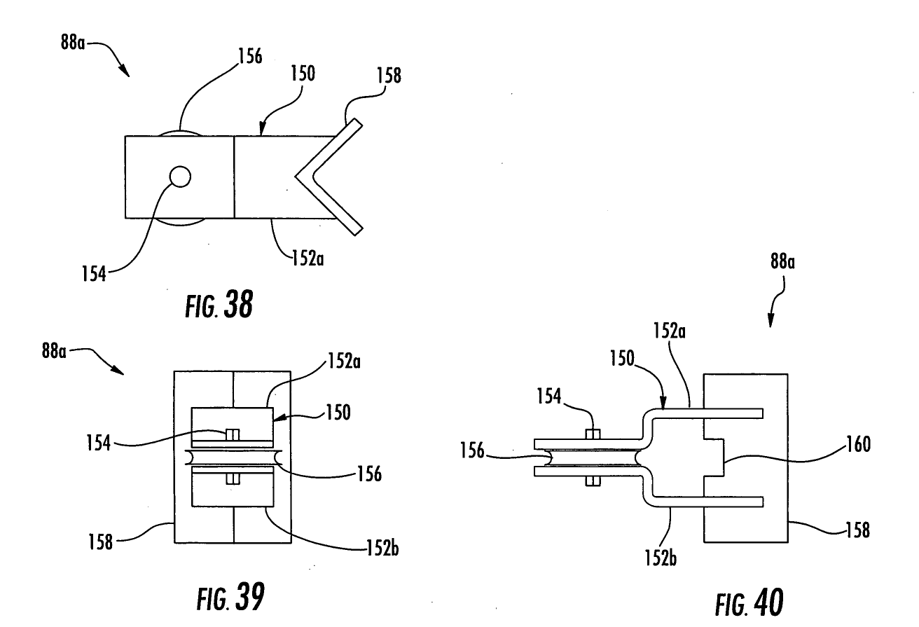

An exemplary dual-use corner pulley 88a is now described with reference to FIGS. 38-40. The dual-use corner pulley 88a includes a yoke 150 comprising two flat s-shaped pulley arms 152a, 152b. The pulley arms 152a, 152b are made of steel flatbar or other suitable material as will be appreciated by those of skill in the art. One end portion of each pulley arm 152a, 152b carries a pulley axle 154 on which a wheel 156 is rotatably mounted. The other end portion of each pulley arm 152a, 152b is connected to a mounting bracket 158.

In one embodiment, the mounting bracket 158 comprises steel angle, which facilitates the connection of the mounting bracket 158 to a corner of a stanchion 16a or beam as will be appreciated by those of skill in the art. This mounting bracket 158 further comprises a fastener slot 160 for connecting the mounting bracket to a stanchion 16a or beam with a welded hex nut as will be appreciated by those of skill in the art. The end portions of each pulley arm 152a, 152b connected to the mounting bracket 158 are v-shaped to receive the steel angle mounting bracket therein. The point of connection between each pulley arm 152a, 152b and the mounting bracket 158 are securely joined by welding or other suitable fastening technique as will be appreciated by those of skill in the art.

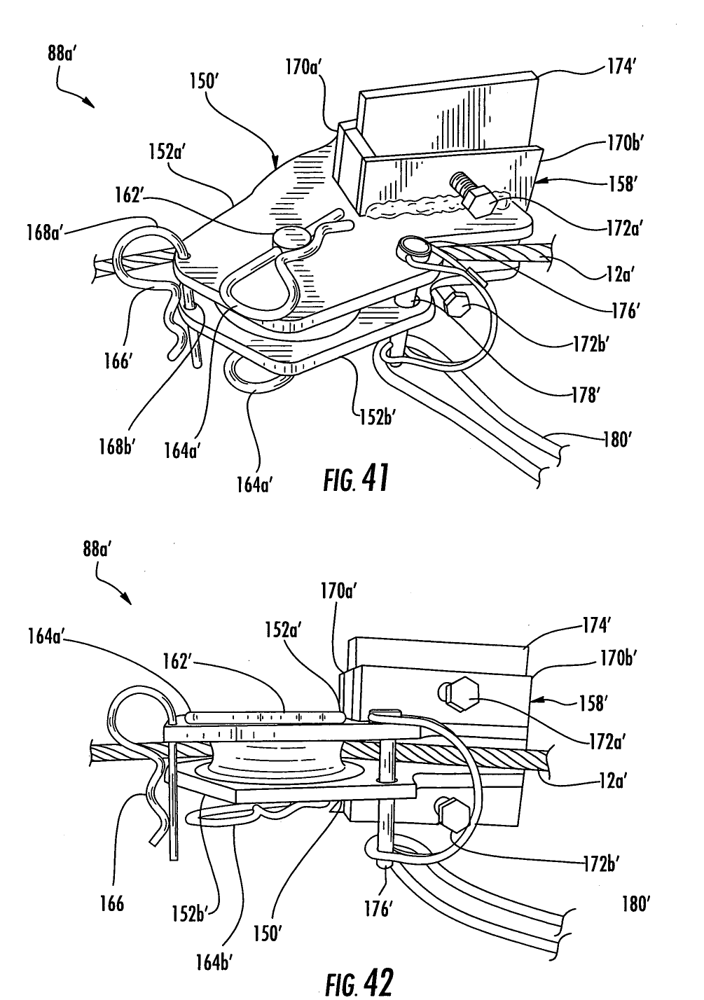

An alternative embodiment of the dual-use corner pulley 88a ′ is now described with reference to FIGS. 41-42. The wheel 156′ is removably carried by the yoke 150′ and secured in place by a removable axle pin 162′, which in turn is secured by cotter pin 164a′ and 164b′. Removal of the wheel 156′ facilitates the positioning of the fall protection cable 12a when the dual-use corner pulley 88a′ is used for an inside corner, for example. For instance, when the fall protection cable 12a is positioned within the yoke 150′, the wheel 156′ is then secured into position by the removable axle pin 162′ thereby permitting the inner surface of the wheel to cooperate with the yoke to capture the fall protection cable even if the cable is in a slack condition.

When the dual-use corner pulley 88a′ is used on an outside corner, an outer surface of the wheel opposite the inner surface cooperates with a removable capture member 166 to capture the fall protection cable even if it is in a slack condition. The capture member 166 is positioned in openings 168a′ and 168b′ in the yoke 150′ as will be appreciated by those of skill in the art.

The mounting bracket 158′ illustratively includes a pair of spaced apart mounting plates 170a′ and 170b′. Each mounting plates 170a′ and 170b′ may include fasteners 172a′ and 172b′, which are used to secure the mounting bracket to a building member, stanchion 16a, or the like as will be appreciated by those of skill in the art.

The dual-use corner pulley 88a′ may further include a weld plate 174′ connected to one of the mounting plates 170a′ and 170b′. The weld plate 174′ is to be secured to a building member, stanchion 16a, or the like by welding thereby provided a secure connection while not damaging the mounting bracket 158′ as will be appreciated by those of skill in the art.

Further, the dual-use corner pulley 88a′ may include a mounting bracket safety tether 180′ for securing the dual-use corner pulley to a respective vertical member. The mounting bracket safety tether 180′ is connected to the mounting bracket 158′ by a removable safety tether pin 176′. The safety tether pin 176′ is positioned in an opening 178′ in the yoke 150′ as will be appreciated by those of skill in the art. The mounting bracket safety tether 180′ is positioned around a building member, stanchion 16a, or the like that the mounting bracket 158′ is secured to thereby providing a backup if such a connection should fail as will be appreciated by those of skill in the art. The mounting bracket safety tether 180′ comprises chain, cable, cord, or the like.

An advantage of the temporary railing 10 may be that a constant and even tension may be maintained for all the sections of the cable run on the fall protection cable 12a. For instance, test data from the experimental temporary railing 10 shown in FIGS. 15-21 have generated a fairly equal tension of 2300-2600 pounds of tension throughout the entire run of cable. In comparison, a test performed on a typical conventional temporary railing system using a turnbuckle tightened by hand and one lever only generated about 700 pounds of tension on the fall protection cable. In addition, a test performed on a typical conventional guardrail fall protection system using a turnbuckle tightened by hand and three levers only generated about 1200 pounds of tension on the fall protection cable.

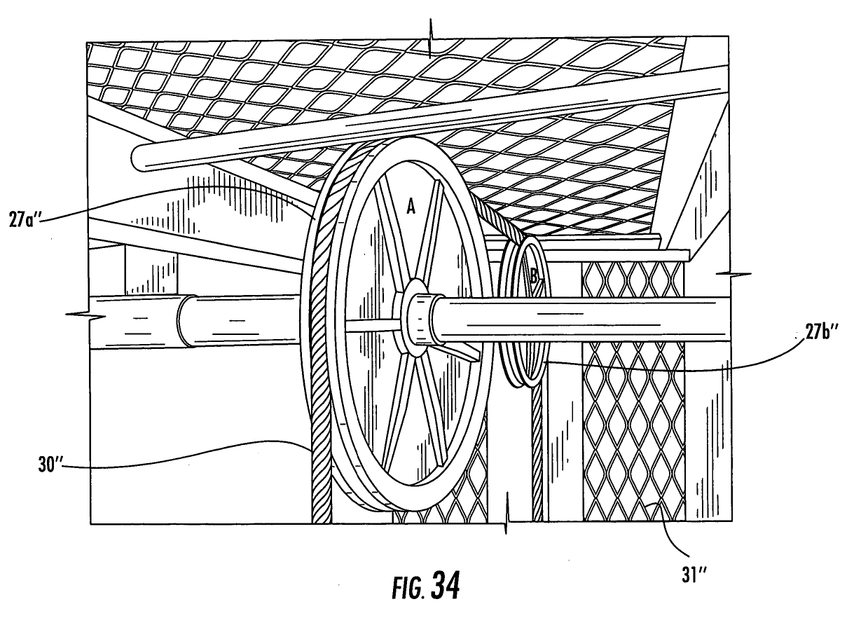

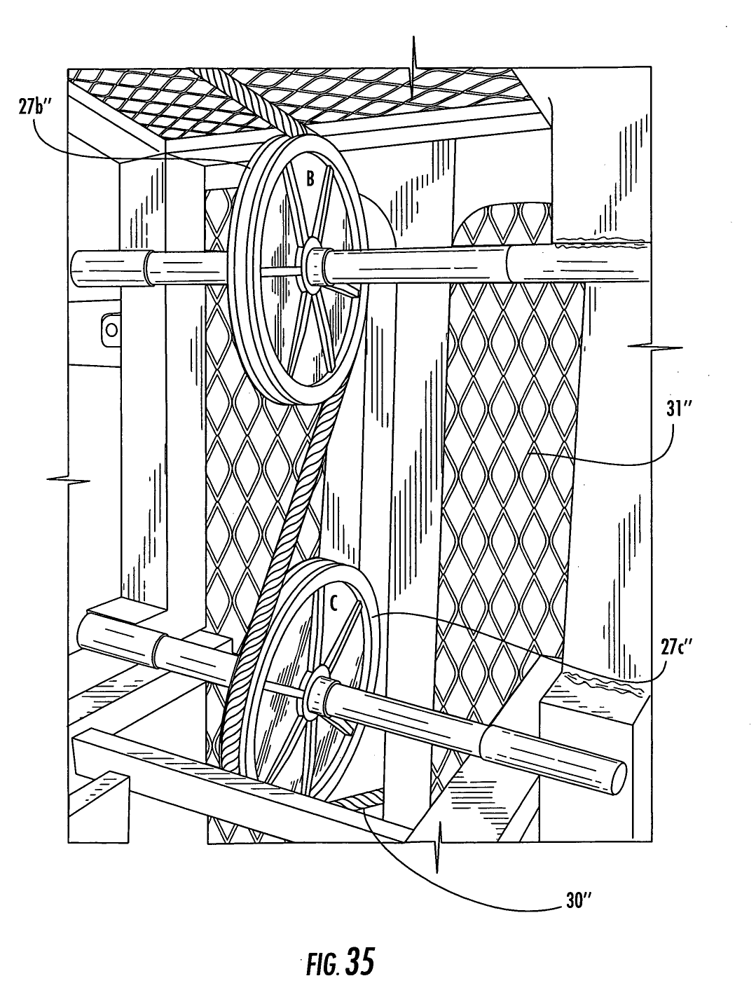

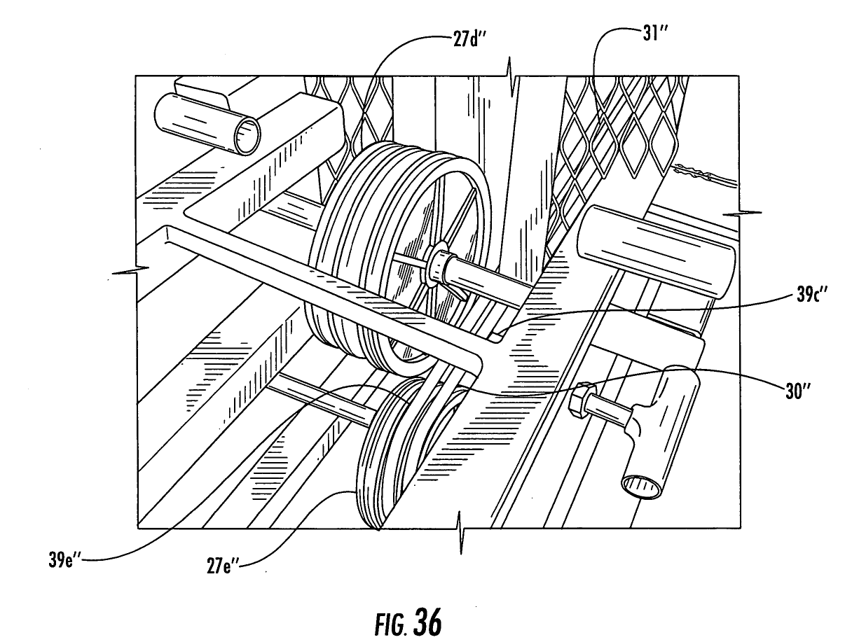

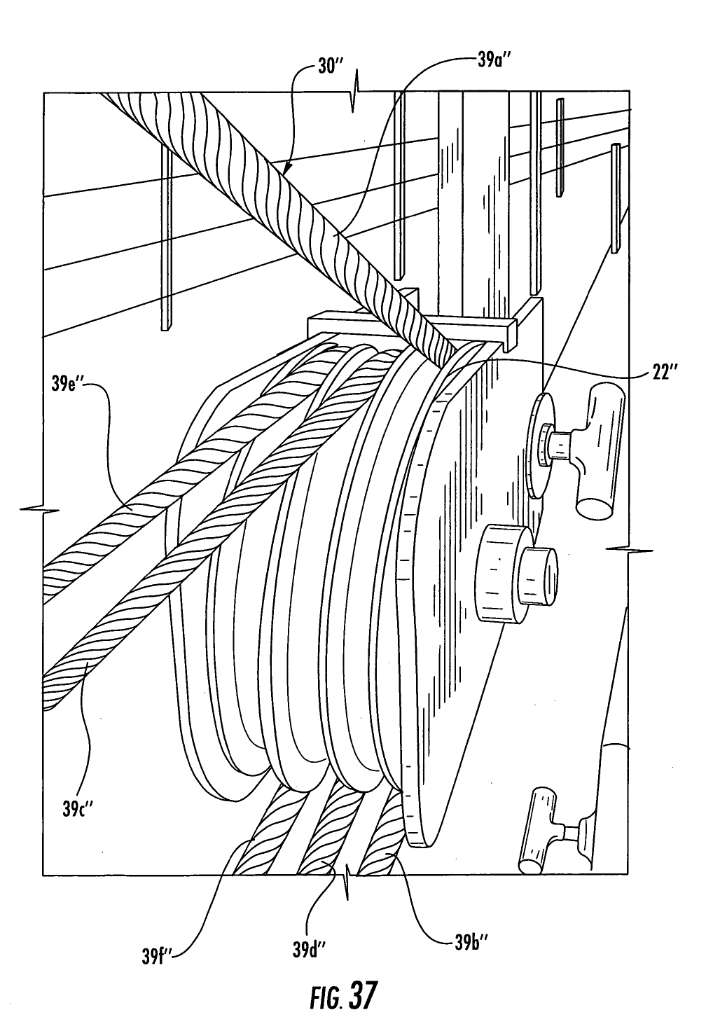

Referring now additionally to FIGS. 33-37, the manner in which the tower cable 30″ is strung through the pulleys 27a″-27e″ to yoke pulley 22″ in one embodiment is now described. The tower cable 30″ is attached to tower weights 32″ at one end as will be appreciated by those of skill in the art. The other end of the tower cable 30″ is strung through the pulleys 27a″ and 27b″ as is best seen in FIG. 34. The tower cable 30″ continues around pulley 27b″ and around pulley 27c″ (FIG. 35) and then the tower cable leaves the tower 20″ to go out to yoke pulley 22″ as tower cable segment 39a″ (FIG. 37). The tower cable segment 39b″ is then routed back into the tower 20″ and around pulley 27d″ or 27e″ (FIG. 36).

The selection of which pulley 27d″ or 27e″ depends on the height requirement of the tower cable 30″ as will be appreciated by those of skill in the art. For example, if the tower 20″ uses all-threaded rods 25a-25d to elevate the tower (FIG. 33), then pulley 27e″ may be employed. In addition, pulleys 27d″ or 27e″ may be replaced by a single pulley on an adjustable track as will be appreciated by those of skill in the art.

The tower cable segment 39c″ is then routed out to and around yoke pulley 22″, and tower cable segment 39d″ goes back to and around pulley 27e″. The tower cable segment 39e″ is then routed out to and around yoke pulley 22″, and the tower cable segment 39f″ returns to attach to the tower set point winch 24″. The amount of mechanical advantage gained by routing the tower cable segments 39a″-39f″ between pulley 27e″ and yoke pulley 22″ may be changed by adding or reducing the number of cable segments passing between the pulley and yoke pulley as will be appreciated by those of skill in the art. The described pulley setup generated a multiplier of 6 to 7 times the weight or force applied.

The tower set point winch 24″ is used to facilitate the tensioning of the tower cable 30″. The mechanical advantage gained by the pulley system of the tower 20″ permits a user to tension the tower cable 30″ with reduced effort as will be appreciated by those of skill in the art.

In addition, other features relating to the temporary railing system are disclosed in co-pending patent applications assigned to the assignee of the present application entitled TEMPORARY RAILING FOR A BUILDING INCLUDING ACCESS OPENING AND ASSOCIATED METHODS, attorney work docket number 59219, and entitled TEMPORARY RAILING FOR A BUILDING INCLUDING DUAL-USE CORNER PULLEY AND ASSOCIATED METHODS, attorney work docket number 59220, the entire disclosures of which are incorporated by reference. Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and other embodiments are intended to be included.

That which is claimed is:

1. A temporary railing for a boundary of a building floor comprising:
a plurality of temporary cable supports spaced along the boundary of the building floor;
a plurality of vertically spaced apart cables carried by said temporary cable supports to extend along the boundary of the building floor; and
a portable cable tensioning apparatus coupled to said cables to maintain a desired tension therein and to take-up slack therein to maintain the desired tension.

2. The temporary railing according to claim 1 wherein said portable cable tensioning apparatus comprises:
a portable frame; and
a weight load movably carried by said portable frame and coupled to said cables.

3. The temporary railing according to claim 2 wherein said weight load comprises a stack of removable plates.

4. The temporary railing according to claim 2 wherein said portable cable tensioning apparatus further comprises a pulley arrangement coupled between said weight load and said cables for multiplying tension applied to said cables by said weight load.

5. The temporary railing according to claim 4 wherein said portable cable tensioning apparatus further comprises:
a winch carried by said portable frame;
a yoke coupled to said cables; and
a take-up cable having a first end coupled to said winch, a second end coupled to said weight load, and a medial portion extending through said yoke and said pulley arrangement.

6. The temporary railing according to claim 5 wherein said portable cable tensioning apparatus further comprises a yoke guide carried by said frame and guiding said yoke.

7. The temporary railing according to claim 1 wherein said portable cable tensioning apparatus comprises:
a portable frame;
a cylinder carried by said portable frame;
a controllable fluid pressure source; and
a piston coupled to said cables and movable within said cylinder responsive to said controllable fluid pressure source.

8. The temporary railing according to claim 1 wherein said portable cable tensioning apparatus comprises at least one tensioning spring.

9. The temporary railing according to claim 1 wherein said plurality of temporary cable supports comprises at least one stanchion temporarily secured to the building floor.

10. The temporary railing according to claim 9 wherein said at least one stanchion has an adjustable height.

11. The temporary railing according to claim 1 wherein the building comprises at least one vertical building member; and wherein said plurality of temporary cable supports comprises at least one pulley temporarily secured to the at least one vertical building member.

12. The temporary railing according to claim 11 wherein said at least one pulley comprises at least one dual-use corner pulley suitable for inside or outside corner mounting.

13. The temporary railing according to claim 1 further comprising an access opening assembly coupled in line with said cables.

14. A portable cable tensioning apparatus for a temporary railing for a boundary of a building floor, the temporary railing comprising a plurality of temporary cable supports spaced along the boundary of the building floor, and a plurality of vertically spaced apart cables carried by the temporary cable supports to extend along the boundary of the building floor, the portable cable tensioning apparatus comprising:
a portable frame;
a weight load movably carried by said portable frame and to be coupled to the cables; and
a pulley arrangement carried by said portable frame to be coupled between said weight load and the cables for multiplying tension applied to the cables by said weight load.

15. The portable cable tensioning apparatus according to claim 14 wherein said weight load comprises a stack of removable plates.

16. The portable cable tensioning apparatus according to claim 14 further comprising:
a winch carried by said portable frame;
a yoke to be coupled to the cables; and
a take-up cable having a first end coupled to said winch, a second end coupled to said weight load, and a medial portion extending through said yoke and said pulley arrangement.

17. The portable cable tensioning apparatus according to claim 16 wherein said portable cable tensioning apparatus further comprises a yoke guide carried by said frame and guiding said yoke.

18. A portable cable tensioning apparatus for a temporary railing for a boundary of a building floor, the temporary railing comprising a plurality of temporary cable supports spaced along the boundary of the building floor, and a plurality of vertically spaced apart cables carried by the temporary cable supports to extend along the boundary of the building floor, the portable cable tensioning apparatus comprising:
a portable frame;
a cylinder carried by said portable frame;
a controllable fluid pressure source carried by said portable frame; and
a piston to be coupled to the cables and movable within said cylinder responsive to said controllable fluid pressure source.

19. The temporary railing according to claim 18 wherein said controllable fluid pressure source comprises at least one of a controllable hydraulic fluid pressure source and a controllable pneumatic fluid pressure source.

20. A method for establishing a temporary railing for a boundary of a building floor comprising:
positioning a plurality of temporary cable supports spaced along the boundary of the building floor;
positioning a plurality of vertically spaced apart cables carried by the temporary cable supports to extend along the boundary of the building floor; and
coupling a portable cable tensioning apparatus to the cables to maintain a desired tension therein and to take-up slack therein to maintain the desired tension.

21. The method according to claim 20 wherein the portable cable tensioning apparatus comprises:
a portable frame; and
a weight load movably carried by the portable frame and coupled to the cables.

22. The method according to claim 21 wherein the weight load comprises a stack of removable plates; and further comprising setting a desired weight load value with the removable plates.

23. The method according to claim 21 wherein the portable cable tensioning apparatus further comprises a pulley arrangement coupled between the weight load and the cables for multiplying tension applied to the cables by the weight load.

24. The method according to claim 23 wherein the portable cable tensioning apparatus further comprises:
a winch carried by the portable frame;
a yoke coupled to the cables; and
a take-up cable having a first end coupled to the winch, a second end coupled to the weight load, and a medial portion extending through the yoke and the pulley arrangement.

25. The method according to claim 24 wherein the portable cable tensioning apparatus further comprises a yoke guide carried by the frame and guiding the yoke.

26. The method according to claim 20 wherein the portable cable tensioning apparatus comprises:
a portable frame;
a cylinder carried by the portable frame;
a controllable fluid pressure source; and
a piston coupled to the cables and movable within the cylinder responsive to the controllable fluid pressure source.

27. The method according to claim 20 wherein the portable cable tensioning apparatus comprises at least one tension spring.

28. The method according to claim 20 wherein positioning the plurality of temporary cable supports comprises temporarily securing at least one stanchion to the building floor.

29. The method according to claim 28 wherein the at least one stanchion has an adjustable height; and further comprising setting the adjustable height of the at least one stanchion.

30. The method according to claim 20 wherein the building comprises at least one vertical building member; and wherein positioning the plurality of temporary cable supports comprises temporarily securing at least one pulley to the at least one vertical building member.
